(19) United States
(12) Patent Application Publication
(10) Pub. No.: US 2015/0061810 A1
(43) Pub. Date: Mar. 5, 2015

(54) MULTILAYER TYPE INDUCTOR AND METHOD OF MANUFACTURING THE SAME

(71) Applicant: SAMSUNG ELECTRO-MECHANICS CO., LTD., Suwon-si (KR)

(72) Inventor: Bong Sup LIM, Busan (KR)

(21) Appl. No.: 14/473,998

(22) Filed: Aug. 29, 2014

(30) Foreign Application Priority Data
Aug. 30, 2013 (KR) 10-2013-0104132

(51) Int. Cl. H01F 27/29; H01F 41/10; H01F 41/04; H01F 27/28

(52) U.S. Cl. CPC H01F 27/29; H01F 27/2804; H01F 41/10; H01F 41/041; H01F 2027/2809
USPC 336/192; 156/89.12

(57) ABSTRACT

Disclosed herein is a multilayer type inductor for implementing high quality factor (Q factor), and more particularly, a multilayer type inductor, including: a ceramic body formed by laminating a plurality of ceramic sheets; a coil electrode provided between the ceramic sheets and having an outer peripheral formed in a curved surface; and a pair of external terminals provided at both side portions of the ceramic body.

### CROSS REFERENCE(S) TO RELATED APPLICATIONS

This application claims the foreign priority benefit under 35 U.S.C. Section 119 of Korean Patent Application Serial No. 10-2013-0104132, entitled “Multilayer Type Inductor and Method of Manufacturing the Same” filed on Aug. 30, 2013, which is hereby incorporated by reference in its entirety into this application.

### BACKGROUND OF THE INVENTION

1. Technical Field

The present invention relates to a multilayer type inductor, and more particularly, to a multilayer type inductor configured by laminating ceramic sheets.

2. Description of the Related Art

An inductor element, which is one of the important passive elements configuring an electronic circuit together with a resistor and a capacitor, is mainly used in a power circuit such as a DC-DC converter in an electronic device and is also widely used as a component removing a noise or configuring an LC resonant circuit.

Meanwhile, miniaturization and thinness of the electronic device together with a development of an IT technology have accelerated, and a market requirement for a miniature and thin element has increased. In accordance with this requirement, an inductor element having a thin film structure has been suggested. Among these, a multilayer type inductor element has widely been used.

Describing a basic structure of a multilayer type inductor with reference to Patent Document 1 (Korean Paten Laid-Open Publication No. 10-2008-0106123), the multilayer type inductor includes a ceramic body having ceramic sheets and metal wirings alternately laminated thereon, and external terminals provided at both side portions of the ceramic body, as a basic configuration. In this case, the metal wirings of each layer are inter-layered through a via to thereby configure a coil so as to function as an inductor by forming magnetic flux when external power is applied thereto through the external terminal.

Meanwhile, the multilayer type inductor having high quality, particularly, high quality factor (Q factor) has recently been required due to complexity, multifunctionality, and the like of the electronic device. Therefore, the multilayer type inductor having a structure for implementing the high Q factor has been suggested in several patent documents.

As an example, referring to Patent Document 2 (Korean Paten Laid-Open Publication No. 10-2012-0023689), Patent Document 2 suggests a method of increasing the Q factor by filling a magnetic material in a predetermined region within an element body. Due to miniaturization and slimness of the component, however, it is practically difficult to prepare a separate space for improving the Q factor within the element, and the above-mentioned structural complication may cause production cost and a manufacturing time to be increased.

### RELATED ART DOCUMENT

### Patent Document

(Patent Document 1) Korean Patent Laid-Open Publication No. 10-2008-0106123

(Patent Document 2) Korean Patent Laid-Open Publication No. 10-2012-0023689

### SUMMARY OF THE INVENTION

An object of the present invention is to provide a multilayer type inductor capable of implementing high quality factor (Q factor) using a simpler structure and a method of manufacturing the same.

According to an exemplary embodiment of the present invention, there is provided a multilayer type inductor including: a ceramic body formed by laminating a plurality of ceramic sheets; a coil electrode provided between the ceramic sheets and having an outer peripheral surface formed in a curved surface; and a pair of external terminals provided at both side portions of the ceramic body.

The coil electrode may have a longitudinal section of a circular shape or an oval shape.

The coil electrode may be buried between a pair of upper side and lower side ceramic sheets which are laminated.

The coil electrode may be configured by a lower electrode buried in the lower side ceramic sheet and an upper electrode buried in the upper side ceramic sheet.

The lower electrode and the upper electrode may have a longitudinal section of a semi-circular shape or a semi-oval shape.

The lower electrode and the upper electrode may be made of the same metal material or different metal materials.

The multilayer type inductor may further include a lead electrode provided on the ceramic sheet and having one end exposed to a side surface of the ceramic body to be connected to the external terminal, wherein the lead electrode may have an outer peripheral surface formed in a curved shape.

According to another exemplary embodiment of the present invention, there is provided a method of manufacturing a multilayer type inductor, the method including: forming a semi-circular groove on a surface of a prepared ceramic sheet; forming a lower electrode by plating and filling an inner portion of the groove; forming a cylindrical coil electrode configured by forming a semi-circular upper electrode on the lower electrode and bonding the lower electrode and the upper electrode to each other; after laminating a plurality of ceramic sheets having the coil electrode formed therein, pressurizing and sintering the laminated ceramic sheets; and forming external terminals at both side surface of the ceramic body formed by the pressurizing and sintering.

The forming of the semi-circular groove on the surface of the ceramic sheet may be performed by pressurizing a cylindrical mold having a coil shape on the ceramic sheet and then removing the mold.

The forming of the upper electrode may be performed by applying a metal paste on the lower electrode and then leveling the metal paste.

### BRIEF DESCRIPTION OF THE DRAWINGS

FIG. 1 is an appearance perspective view of a multilayer type inductor according to an exemplary embodiment of the present invention;

FIG. 2 is a cross-sectional view taken along the line I-I′ of FIG. 1;

FIG. 3 is a partially cut-away view of one ceramic sheet having a coil electrode formed thereon;

FIG. 4 is a graph showing a change in a Q factor depending on a frequency in an inductor element according to the related art and an inductor element according to the present invention;

FIG. 5 is a perspective view of one ceramic sheet having a lead electrode formed thereon; and

FIGS. 6 to 10 are process views sequentially showing processes of printing the coil electrode on the ceramic sheet.

### DESCRIPTION OF THE PREFERRED EMBODIMENTS

Various advantages and features of the present invention and technologies accomplishing thereof will become apparent from the following description of exemplary embodiments with reference to the accompanying drawings. However, the present invention may be modified in many different forms and it should not be limited to exemplary embodiments set forth herein. These exemplary embodiments may be provided so that this disclosure will be thorough and complete, and will fully convey the scope of the invention to those skilled in the art.

Terms used in the present specification are for explaining exemplary embodiments rather than limiting the present invention. Unless explicitly described to the contrary, a singular form includes a plural form in the present specification. Components, steps, operations, and/or elements stated herein do not exclude the existence or addition of one or more other components, steps, operations and/or elements.

Hereinafter, a configuration and an acting effect of exemplary embodiments of the present invention will be described in more detail with reference to the accompanying drawings.

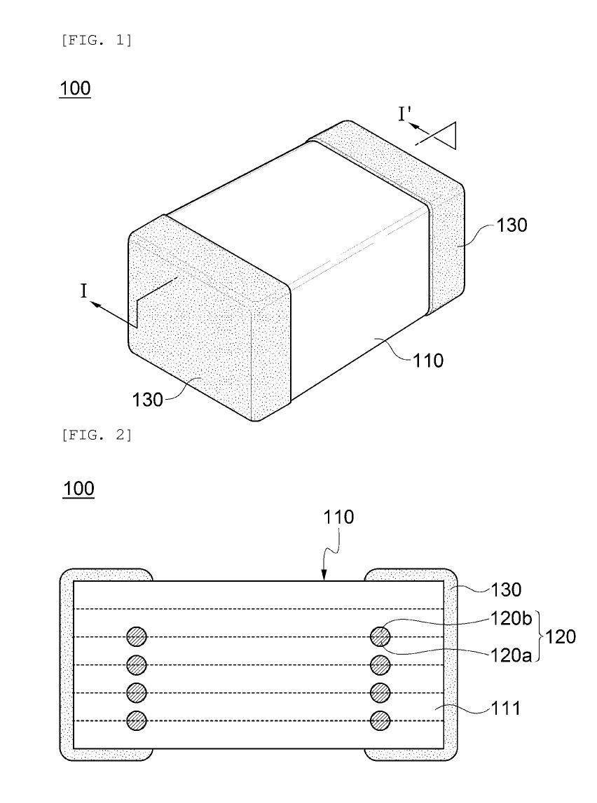

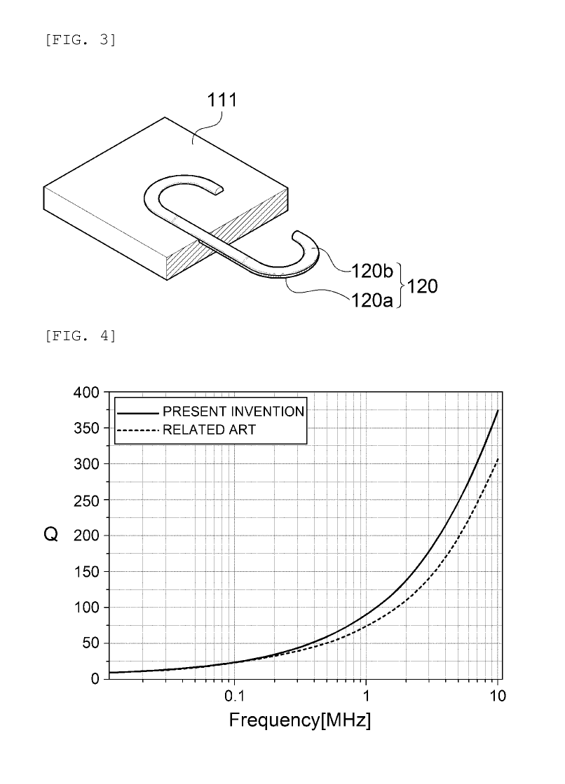

FIG. 1 is an appearance perspective view of a multilayer type inductor according to an exemplary embodiment of the present invention, FIG. 2 is a cross-sectional view taken along the line I-I′ of FIG. 1, and FIG. 3 is a partially cut-away view of one ceramic sheet having a coil electrode formed thereon. Additionally, components shown in the accompanying drawings are not necessarily shown to scale. For example, sizes of some components shown in the accompanying drawings may be exaggerated as compared with other components in order to assist in the understanding of the exemplary embodiments of the present invention. Meanwhile, throughout the accompanying drawings, the same reference numerals will be used to describe the same components. For simplification and clearness of illustration, a general configuration scheme will be shown in the accompanying drawings, and a detailed description of the feature and the technology well known in the art will be omitted in order to prevent a discussion of exemplary embodiments of the present invention from being unnecessarily obscure.

Referring to FIGS. 1 and 3, a multilayer type inductor 100 according to an exemplary embodiment of the present invention may be configured to include a ceramic body 110 having coil electrodes 120 embedded therein, and a pair of external terminals 130 provided at both side portions of the ceramic body 110.

The ceramic body 110, which is a hexahedron made of a ceramic material manufactured at a size corresponding to a predetermined chip size, for example, 2012 (2.0 mm×1.2 mm×1.2 mm), 1005 (1.0 mm×0.5 mm×0.5 mm), 0603 (0.6 mm×0.3 mm×0.3 mm), or 0402 (0.4 mm×0.2 mm×0.2 mm) size, may be formed by, after laminating a plurality of ceramic sheets 111 having Fe—Ni—Zn oxide based, Fe—Ni—Zn—Cu oxide based, or metal based ferrite such as Fe, Ni, Fe—Ni (Permalloy), or the like as a main component in a thickness direction, pressurizing and sintering the laminated ceramic sheets 111. Therefore, the ceramic sheets 111 adjacent to each other may be integrated with each other so as not to confirm a boundary therebetween, thereby forming the ceramic body 110.

The coil electrodes 120, which are metal wirings of a coil pattern made of at least one material selected from Ni, Al, Fe, Cu, Ti, Cr, Au, Ag, Pd, and Pt having excellent electrical conductivity, may be provided, having at least one ceramic sheet 111 therebetween. The coil electrodes 120 of each layer are sequentially inter-layered through a conductive via (not shown) penetrating through the ceramic sheet 111 therebetween to thereby form a coil structure winding in a spiral shape.

Here, the present invention may configure an outer peripheral surface of the coil electrode 120 in a curved surface shape. That is, a metal wiring configuring a coil in the inductor element according to the related art, which is generally a rectangular shape, has corners formed to be angled, but the coil electrode 120 according to the present invention may have the outer peripheral surface entirely configured in the curved surface shape so as not to have angled portions unlike the related art.

As an operating frequency of the inductor element is increased, characteristic of the inductor element is affected by a length, a width, a thickness and a cross-section shape of the metal wiring. Specifically, in the inductor element according to the related art including the metal wiring having a longitudinal section shape of a rectangular shape, a current flowing in the metal wiring is channeled at an angled corner portion, such that a resistance is increased. In addition, this phenomenon is further intensified as the operating frequency is increased. As a result, the inductor element according to the related art shows characteristic that quality factor (Q factor) is sharply decreased in a high frequency band.

However, in the case in which the outer peripheral of the coil electrode 120 is configured by the curved surface as in the present invention, the current flowing in the coil electrode 120 is distributed without being channeled at any one portion, such that high Q factor may be maintained even in the high frequency region. Particularly, current distribution effect as mentioned-above may be maximized in a circle in which radiuses of curvature at all portions are equal to one another. Therefore, the coil electrode 120 is formed in a cylindrical shape, such that a longitudinal section shape thereof may be configured in the circle. However, the shape of the coil electrode is not limited thereto. For example, the coil electrode may have the longitudinal section shape configured in an oval.

FIG. 4 is a graph showing a change in a Q factor depending on a frequency in an inductor element according to the related art and an inductor element according to the present invention. Here, the coil electrode having the longitudinal section shape of a rectangle (line width 100 μm×thickness 60 μm) was used in the inductor element according to the related art, and the cylindrical coil electrode 120 having the longitudinal section shape of the circle (diameter 87.4 μm) was used in the present invention. Except for that, a simulation was performed by configuring the number of turns and a length of the coil electrode, a configuration material, and the like to be equal to the related art.

Referring to FIG. 4, it may be appreciated that the inductor element according to the present invention shows the higher Q factor than the inductor element according to the related art, and particularly, a difference therebetween is gradually increased toward the high frequency. This is due to a difference in current density in the coil electrode as described above, and an effect thereof may be greatly increased as the number of turns, the length, and the like of the coil electrode 120 are increased.

The coil electrode 120 having the shape described above may be provided to be buried between a pair of ceramic sheets 111 of upper and lower sides. That is, the coil electrode 120 may be configured by a lower electrode 120a buried in the ceramic sheet 111 of the lower side and an upper electrode 120b buried in the ceramic sheet 111 of the upper side.

Here, the lower electrode 120a and the upper electrode 120b may be separately manufactured according to a method of manufacturing the multilayer type inductor. Therefore, the lower electrode 120a and the upper electrode 120b may be bonded while forming an interface therebetween. Therefore, in the case in which the coil electrode 120 has the longitudinal section shape of the circle, the lower electrode 120a and the upper electrode 120b may be configured to have the longitudinal shape of a semi-circle. Similarly, in the case in which the coil electrode 120 has the longitudinal section shape of the oval, the lower electrode 120a and the upper electrode 120b may be configured to have the longitudinal shape of a semi-oval.

Examples of the configuration material of the lower electrode 120a and the upper electrode 120b may include at least one material selected from Ni, Al, Fe, Cu, Ti, Cr, Au, Ag, Pd, and Pt having excellent electrical conductivity. The lower electrode 120a and the upper electrode 120b may be made of the same material as each other, or may be made of different materials.

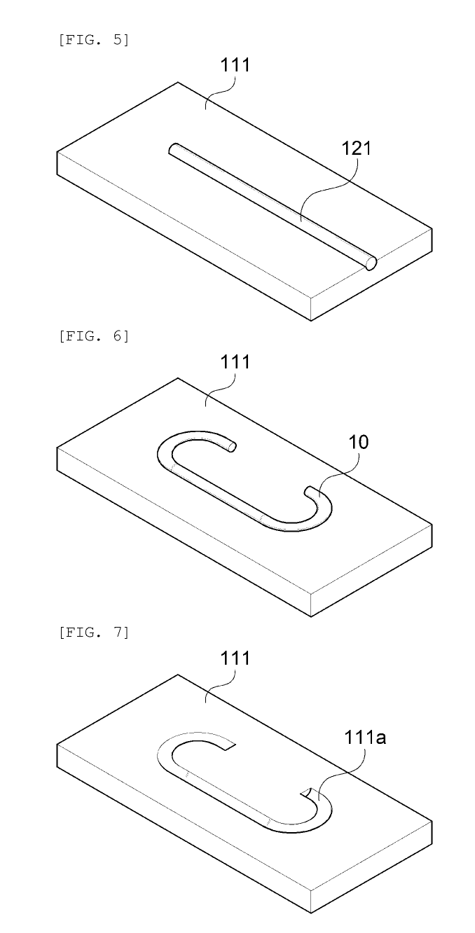

Meanwhile, one end of the coil electrode 120 disposed at an uppermost layer and a lowest layer is extended to a side surface of the ceramic body 110 to be connected to the external terminal 130, such that the coil electrode 120 and the external terminal 130 may be connected to each other. Alternatively, as shown in FIG. 5, the coil electrode 120 and the external terminal 130 may be connected to each other through the lead electrode 121 formed separately on the ceramic sheet 111.

That is, one end of the lead electrode 121 may be exposed to the side surface of the ceramic body 110 to be connected to the external terminal 130, and the other end may be connected to the coil electrode 120 of the uppermost layer or the lowest layer through a conductive via (not shown). In this case, the lead electrode 121 may also have the outer peripheral surface formed in the curved surface in order to implement the high Q factor.

Hereinafter, a method of manufacturing the multilayer type inductor 100 according to an exemplary embodiment of the present invention will be described.

The method of manufacturing the multilayer type inductor according to the exemplary embodiment of the present invention is not largely different from the general method of manufacturing the multilayer type inductor which is already known in several patent documents. That is, the multilayer type inductor may be completed by printing and forming the coil electrodes 120 in the ceramic sheets 111, after laminating a plurality of ceramic sheets 111 having the coil electrodes 120 formed therein, pressurizing and sintering the laminated ceramic sheets 111, and forming the external terminals 130 at both side portions of the obtained ceramic body 110 by a dipping process.

As described above, however, in order to manufacture the outer peripheral surface of the coil electrode 120 to have the curved surface, particularly, to allow the longitudinal section thereof to be the circle, a process of printing the coil electrode 120 different from the method according to the related art needs to be performed. This will be described in detail with reference to FIGS. 6 to 10.

FIGS. 6 to 10 are process views sequentially showing processes of printing the coil electrode 120 on the ceramic sheet 111. For example, in order to print the cylindrical coil electrode 120 having the longitudinal section shape of the circle, first a semi-circular groove (reference numeral 111a of FIG. 7) is formed on a surface of the prepared ceramic sheet 111.

This groove may be formed by pressurizing a cylindrical mold (reference numeral 10 of FIG. 6) having the coil shape on the ceramic sheet 111 and then removing the mold. Here, the cylindrical mold 10 have the same pattern as the coil electrode 120 to be formed. Therefore, as shown in FIG. 6, when the cylindrical mold 10 is seated on the ceramic sheet 111, is pressurized using a press machine, or the like, and is then removed, the semi-circular groove 111a of a lower electrode (120a) pattern may be formed on the surface of the ceramic sheet 111, as shown in FIG. 7.

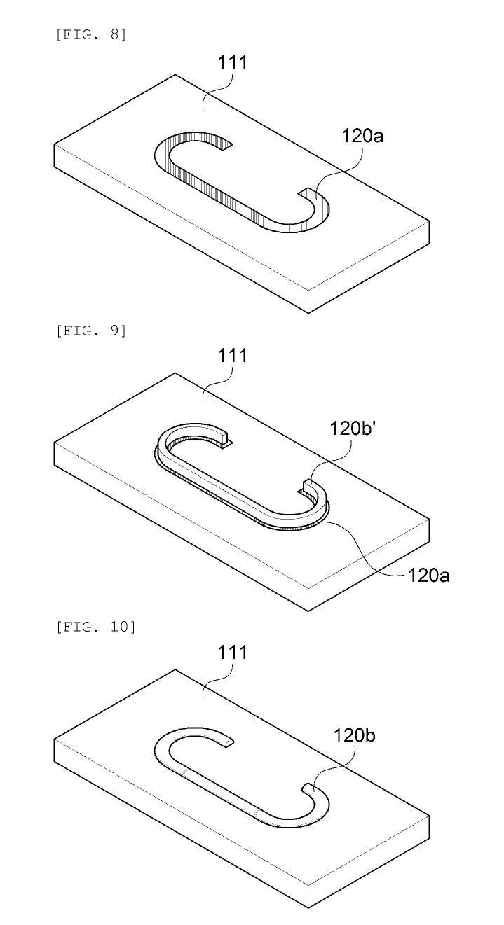

In addition, the lower electrode 120a is formed by plating and filling an inner portion of the groove 111a formed as mentioned above (FIG. 8). The filling process may be performed by filling at least one metal material selected from Ni, Al, Fe, Cu, Ti, Cr, Au, Ag, Pd, and Pt using any one of electroless plating method, electroplating method, a screen printing method, a sputtering method, an evaporation method, an ink-jetting method, and a dispensing method, or a combination thereof.

Next, finally, a semi-circular upper electrode 120b is formed on the lower electrode 120a, such that the cylindrical coil electrode 120 formed by bonding the lower electrode 120a and the upper electrode 120b to each other may be finally completed (FIG. 10).

The forming of the upper electrode 120b may be performed by applying a metal paste 120b′ on the lower electrode 120a and then performing a leveling process, as shown in FIG. 9. Here, as materials of the metal paste 120b′, at least one material selected from Ni, Al, Fe, Cu, Ti, Cr, Au, Ag, Pd, and Pt. In this case, the same metal material as the metal material used in forming the lower electrode 120a may be used or metal materials different from the above-mentioned metal material may be used.

When applying the metal paste 120b′, the metal paste 120b′ is thinly applied so as not to cross a line width of the lower electrode 120a as shown in FIG. 9. Therefore, the applied metal paste 120b′ is leveled so as to match the line width of the lower electrode 120a during the leveling process, thereby making it possible to form the upper electrode 120b having a shape similar to the semi-circle.

Once the ceramic sheet 111 including the cylindrical coil electrode 120 through the processes as described above is manufactured, the ceramic body 110 is completed by, after laminating the plurality of ceramic sheets 111 in the thickness direction, pressurizing and sintering the laminated ceramic sheets 111 and the external terminals 130 are formed at both side portions of the ceramic body 110 by performing the dipping process, such that the multilayer type inductor 100 according to the exemplary embodiment of the present invention may be finally completed.

According to the exemplary embodiment of the present invention, the current flowing in the coil electrode may be distributed without being channeled at any one portion of the coil electrode, such that the high Q factor may be maintained in the high frequency region.

In addition, it is possible to implement the high Q factor by only changing the structure of the coil pattern without adding the separate configuration, such that the product may be produced without increasing the production cost and the manufacturing time.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. A multilayer type inductor, comprising:
a ceramic body formed by laminating a plurality of ceramic sheets;
a coil electrode provided between the ceramic sheets and having an outer peripheral surface formed in a curved surface; and
a pair of external terminals provided at both side portions of the ceramic body.

2. The multilayer type inductor according to claim 1, wherein the coil electrode has a longitudinal section of a circular shape or an oval shape.

3. The multilayer type inductor according to claim 1, wherein the coil electrode is buried between a pair of upper side and lower side ceramic sheets which are laminated.

4. The multilayer type inductor according to claim 3, wherein the coil electrode is configured by a lower electrode buried in the lower side ceramic sheet and an upper electrode buried in the upper side ceramic sheet.

5. The multilayer type inductor according to claim 4, wherein the lower electrode and the upper electrode have a longitudinal section of a semi-circular shape or a semi-oval shape.

6. The multilayer type inductor according to claim 4, wherein the lower electrode and the upper electrode are made of the same metal material or different metal materials.

7. The multilayer type inductor according to claim 1, further comprising a lead electrode provided on the ceramic sheet and having one end exposed to a side surface of the ceramic body to be connected to the external terminal, the lead electrode having an outer peripheral surface formed in a curved shape.

8. A method of manufacturing a multilayer type inductor, the method comprising:
forming a semi-circular groove on a surface of a prepared ceramic sheet;
forming a lower electrode by plating and filling an inner portion of the groove;
forming a cylindrical coil electrode configured by forming a semi-circular upper electrode on the lower electrode and bonding the lower electrode and the upper electrode to each other;
after laminating a plurality of ceramic sheets having the coil electrode formed therein, pressurizing and sintering the laminated ceramic sheets; and
forming external terminals at both side surface of the ceramic body formed by the pressurizing and sintering.

9. The method according to claim 8, wherein the forming of the semi-circular groove on the surface of the ceramic sheet is performed by pressurizing a cylindrical mold having a coil shape on the ceramic sheet and then removing the mold.

10. The method according to claim 8, wherein the forming of the upper electrode is performed by applying a metal paste on the lower electrode and then leveling the metal paste.
